(19) United States
(12) Patent Application Publication
(10) Pub. No.: US 2008/0174440 A1
(43) Pub. Date: Jul. 24, 2008

(54) Method of monitoring an abducted child

(76) Inventor: Abeer Batshon, Los Angeles, CA (US)

Correspondence Address: JAMES RAY & ASSOCIATES, 2640 PITCAIRN ROAD, MONROEVILLE, PA, 15146, US

(21) Appl. No.: 11/786,564

(22) Filed: Apr. 12, 2007

Related U.S. Application Data
(60) Provisional application No. 60/885,647, filed on Jan. 19, 2007.

(51) Int. Cl. G08B 23/00; G08B 1/08

(52) U.S. Cl. 340/573.4; 340/539.15

(57) ABSTRACT

A method of tracking a child at least when the child is away from a pre-selected area. The method comprising the steps of attaching a transmitter to at least one of a pre-selected item of clothing and a pre-selected body part. Transmitting a continuous signal from such transmitter to a receiver for picking up the signal. Monitoring the receiver on a substantially continuous basis. Such monitoring occurring at least one of in a pre-selected area and all areas. Immediately notifying at least one of the police and parents when an emergency situation occurs and thereafter responding to such notification of the emergency situation.

### CROSS REFERENCE TO RELATED APPLICATION

This patent application is related to and claims priority from U.S. Provisional Patent Application Ser. No. 60/885,647 filed Jan. 19, 2007.

### FIELD OF THE INVENTION

The present invention relates, in general, to child safety and, more particularly, this invention relates to a method of monitoring the location of an abducted child.

### BACKGROUND OF THE INVENTION

Prior to the conception and development of the present invention, as is generally well known in the prior art, parents have been constantly concerned with respect to the overall safety of their children. This has become even more of a concern in recent times due to the numerous reports of in the daily news cast about children being abducted or have been reported missing for some unexplained reason. Consequently, parents have good reason to be concerned.

As has been well documented, pedophiles and child molesters are constantly preying on vulnerable children. Presently, there is no readily available method of keeping track of the location of a child at all times they are away from home. Additionally, the police normally require that a child be missing for 24 hours before they will get involved absent a ransom note, for example.

These drawbacks to the present system can result in an increased chance of the child being killed, sexually assaulted or physically harmed and as is well known the person committing these acts is not always caught.

### SUMMARY OF THE INVENTION

The present invention provides a method of tracking a child that is away from home or some other designated area. The method comprising the steps of attaching a transmitter to at least one of a pre-selected item of clothing and a pre-selected body part. Transmitting a continuous signal from such transmitter to a receiver capable of picking up such signal. Monitoring the receiver on a substantially continuous basis. The monitoring occurring at least one of in a pre-selected area and all areas. Immediately notifying at least one of the police and parents when an emergency situation occurs and thereafter immediately responding to the notification of such emergency situation.

### OBJECTS OF THE INVENTION

It is, therefore, one of the primary objects of the present invention to provide a method of tracking a child which is relatively inexpensive to produce.

Another object of the present invention is to provide a method of tracking a child which can be monitored on a 24 hour basis if desired.

Still another object of the present invention is to provide a method of tracking a child which will significantly reduced the chances of the child being harmed by reducing the response time to an emergency situation.

Yet another object of the present invention is to provide a method of tracking a child which can utilize global positioning technology for locating lost children.

An additional object of the present invention is to provide a method of tracking a child which is easy to operate.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF A PRESENTLY PREFERRED AND VARIOUS ALTERNATIVE EMBODIMENTS OF THE INVENTION

In the presently preferred embodiment of the invention there is provided a method of tracking a child when the child is away from their parents or away from home in order to provide added security. According to the method there is a transmitter attached to at least one of a pre-selected item of clothing and a pre-selected body part of the child. Such body part would preferably be under an arm so that it is not noticeable.

Alternatively, the method includes hiding such transmitter in the child's clothing in one of an inner surface of such clothing and a pocket. Most preferably, the transmitter will be disposed on an inner surface of such cloths.

There is a continuous signal transmitted from the transmitter to a receiver for picking up such signal. Preferably, on a substantially continuous basis the receiver is monitored off-site to substantially ensure the location of the child at all times. Such monitoring occurring at least one of in a pre-selected area and in all areas where the child being monitored is likely to be. Preferably, such monitoring will occur in all areas.

During such monitoring at least one of the police and the parents of the child will be immediately notified when an emergency situation occurs. Additionally, upon such notification of the emergency situation there will be an immediately responding thereto.

According to the method such tracking includes tracking by using a global positioning system which will provide an exact location of such child.

Further, the method will preferably include the additional steps of removing such transmitter from the clothing when such clothing is removed and thereafter reattaching such transmitter to such one of the clothing and such pre-selected body part.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A method of tracking a child when away from home, said method comprising the steps of:
(a) attaching a transmitter to at least one of a pre-selected item of clothing and a pre-selected body part;
(b) transmitting a continuous signal from said transmitter to a receiver for picking up said signal;
(c) monitoring said receiver on a substantially continuous basis, said monitoring occurring at least one of in a pre-selected area and all areas;
(d) immediately notifying at least one of police and parents when an emergency situation occurs; and
(e) immediately responding to said notification of said emergency situation.

2. A method of tracking a child when away from home, according to claim 1, wherein said includes hiding said transmitter in said child's clothing in one of an inner surface and a pocket.

3. A method of tracking a child when away from home, according to claim 2, wherein said method includes disposing said transmitter on an inner surface of said cloths.

4. A method of tracking a child when away from home, according to claim 1, wherein said tracking includes tracking by using a global positioning system.

5. A method of tracking a child when away from home, according to claim 4, wherein said global positioning system will provide an exact location of said child.

6. A method of tracking a child when away from home, according to claim 1, wherein said method includes monitoring said signal by an off-site monitoring service.

7. A method of tracking a child when away from home, according to claim 1, wherein said monitoring is done in all locations.

8. A method of tracking a child when away from home, according to claim 2, wherein said method includes the additional steps of:
(f) removing said transmitter from said clothing when said clothing is removed; and
(g) thereafter reattaching said transmitter to said one of said clothing and said pre-selected body part.
